(19) United States
(12) Patent Application Publication
(10) Pub. No.: US 2019/0358834 A1
(43) Pub. Date: Nov. 28, 2019

(54) Modular Electric Hair-Cutting Devices and Methods

(71) Applicant: DueTT, LLC, Starkville, MS (US)

(72) Inventors: Tyler Albert Anthony, Starkville, MS (US); Thomas Gerard White, Starkville, MS (US)

(73) Assignee: DueTT, LLC, Starkville, MS (US)

(21) Appl. No.: 16/418,010

(22) Filed: May 21, 2019

Related U.S. Application Data
(60) Provisional application No. 62/675,173, filed on May 23, 2018.

(51) Int. Cl. B26B 19/38; B26B 19/28

(52) U.S. Cl. CPC B26B 19/388; B26B 19/28

(57) ABSTRACT

A modular electric hair cutting device that has a housing, a hair-cutting module contained in a first end of the housing, the hair-cutting module has blades for cutting hair, the hair-cutting module having at least one sensor coupled to and configured for detecting a temperature of the hair-cutting module, and a cooling module contained in a second end of the housing, the cooling has a fan and cools the internal components of the housing. Further, the modular electric hair-cutting device has a processor that receives data indicative of a temperature from the at least one sensor contained in the hair-cutting module and compares the temperature to a threshold temperature, and the processor activates a first fan if the temperature is greater than the threshold temperature.

### BACKGROUND OF THE DISCLOSURE

Barbers often use electric hair cutting devices when cutting an individual's hair. The electric hair cutting devices typically have a cutting module that comprises a blade. In operation, the hair cutting devices often heat up rapidly to high temperatures. This often causes the hair cutting devices to overheat. In this regard, when the hair cutting devices overheat the barber is unable to sustain all day use without the electric hair-cutting devices becoming excessively hot and overheating. Furthermore, when the hair cutting devices are in continuous or frequent use, they often fail to sustain a comfortable operating temperature for its motor, enclosure, and consequently its internal components which overheat the device. Note that once the hair cutting device overheats, the barber is forced to change to a different hair cutting device.

There exist some solutions that attempt to mitigate blade overheating and keep temperatures within the hair cutting device enclosure low. For example, some hair cutting devices use heat-resistant materials for its enclosure. However, these solutions fail to sustain the continuous and/or frequent use which the barber requires. While they do temporarily reduce the discomfort the operator experiences initially, as the device continues to operate its temperature continuously rises. This inevitably causes the device to overheat and forces its operator to switch to another device.

### BRIEF DESCRIPTION OF THE DRAWINGS

The system is described with reference to the accompanying drawings. In the drawings, like reference numbers indicate identical or functionally similar elements. Additionally, the left-most digit(s) of a reference number identifies the drawing in which the reference number first appears.

FIG. 1 is a perspective view of an exemplary modular hair-cutting device in accordance with an embodiment of the present disclosure.

FIG. 2 is a cross-sectional plan view of the modular hair-cutting device shown in FIG. 1.

FIG. 3 is a cross-sectional perspective view of the modular hair-cutting device shown in FIG. 1.

FIG. 4 is a block diagram of an exemplary controller of the modular hair-cutting device shown in FIG. 1.

FIG. 5 is a flowchart of exemplary architecture and functionality of the hair-cutting device shown in FIG. 1.

### DETAILED DESCRIPTION

The electric hair-cutting device of the present disclosure at a barber's workstation barber and/or their clients the discomfort felt as an electric hair-cutting device overheats. In one embodiment, the electric hair-cutting device is modular taking both the form and function of whichever device the barber requires. For example, a head of the hair-cutting device has an interchangeable head so that the hair-cutting device my serve as a clipper, a trimmer, or shaver during the course of cutting a client's hair.

Additionally, the electric hair-cutting device comprises an autonomous temperature control, which maintains the optimal operating temperature to sustain all day and/or extended use and protect the components of the device. In one embodiment, the hair-cutting device has one motor dedicated to the blade assembly for cutting and a second motor for controlling a cooling device. In the embodiment, the hair-cuter device autonomously controls an internal fan for temperature regulation purposes while the cutting elements are not in use. Therefore, the hair-cutting device of the present disclosure provides a single electric hair-cutting device capable of functioning as a clipper, a trimmer, or a shaver and autonomously maintains a predetermined temperature while its cutting elements are active and/or inactive.

The hair-cutting device of the present disclosure is made up of the following components: cutting module power switch, cooling module power switch, temperature control feedback circuit, cutting module motor and blade driving piece, cooling module motor, temperature and or humidity sensor(s), module enclosure(s) which may or may not have attachable/detachable elements, cutting blade, still blade, cutting blade drive assembly, cooling module fan.

The cutting module comprises a cutting blade, still blade, and motor at the front-end termination. The cutting module is securely attached to an autonomous cooling module which drives a second motor equipped with a fan mounted to its rotor that autonomously circulates ambient air about and around the system in response to temperature sensor readings which exceed the predetermined temperature range within the device.

In one embodiment, the hair-cutting device may comprise a second fan mounted on the rotor of the cutting module's motor. In another embodiment, the hair-cutting device may comprise ventilation slits on the autonomous cooling module and/or cutting module's enclosure(s), contoured hand grips on the autonomous cooling module and or cutting module, attachable/detachable hair cutting module to function as clipper, trimmer, or shaver, a detachment/reattachment system for the rapid interchangeability of the device or system, and a swivel cord to prevent cord bending and/or component damage.

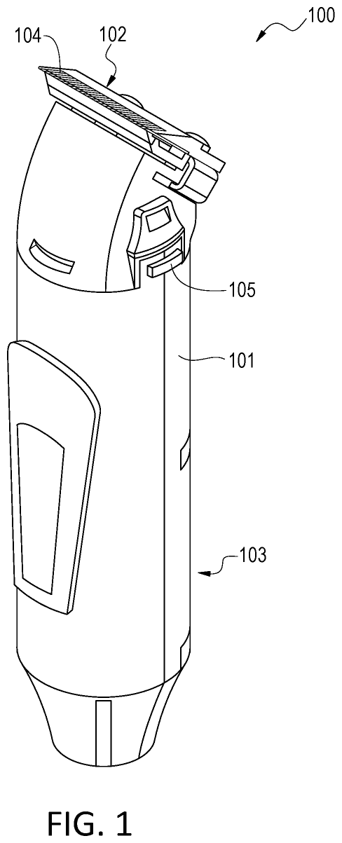

FIG. 1 is a perspective view of a hair-cutting device 100 in accordance with an embodiment of the present disclosure. The hair-cutting device 100 comprises a housing 103. The hair-cutting device 100 comprises a gripper portion 101 that a barber grasps while the hair-cutting device 100 is in use. Note that portions of the gripper portion 101 may be contoured for easier grasping.

The hair-cutting device 100 is electric. Thus, the hair-cutting device 100 comprises a power cord (now shown) that extends from a housing 103 of the hair-cutting device 100 to a wall power receptacle. In one embodiment, the cord may be a swivel cord that prevents the cord from bending and/or causing component damage.

The hair-cutting device 100 comprises a cutting head 102. The cutting head 102 comprises at least a blade assembly 104 for cutting a client's hair. The cutting head 102 also comprises a latch mechanism 105 so that the cutting head 102 may be removed from the handle 101. Once removed, a clipper head (not shown), a trimmer head (not shown), or a shaver head (not shown) may replace the cutter head 102. This enables more versatile use of the hair-cutting device 100.

Note that on the outside surface of the handle 101 there may be power switches. In one embodiment, there is a switch that when activated powers on the cutting head 102. In another embodiment, there is also a switch that when activated powers on an autonomous cooling system, which is described further herein

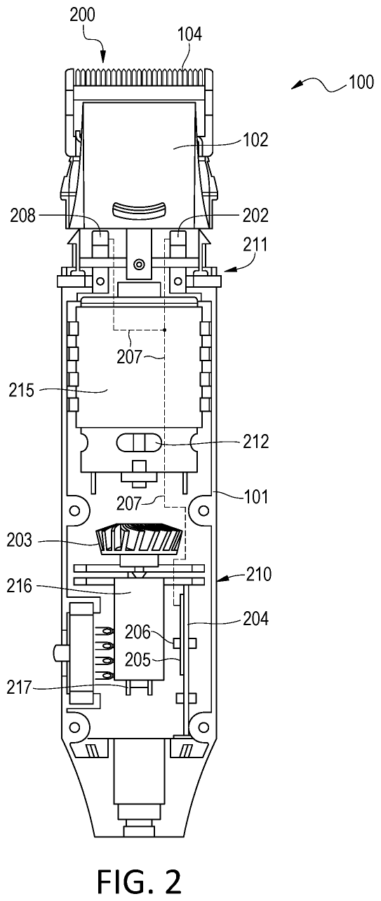

FIG. 2 is a cross-sectional view of the hair-cutting device 100 where the cutting head 102 has been removed from the handle 101 of the hair-cutting device 100. This is shown in this manner to expose temperature sensors 202 and 208, which are described further herein. Note that in one embodiment, the sensors 202 and 208 detect humidity.

The hair-cutting device 100 comprises a hair cutting module 211 and an autonomous cooling module 210. The hair-cutting module 211 comprises a switch 212, as described hereinabove. The switch 212 activates the hair cutting module 211 separate and apart from the autonomous cooling module 210.

The switch 212 activates a rotary motor 215 of the hair-cutting module 211. The motor 215 drives the cutting blade assembly 104 or any other type of head attached to the handle 101 when the switch 212 is activated.

Coupled in the hair-cutting module 211 is a plurality of temperature sensors. In the embodiment shown, the hair-cutting device 100 comprises two temperature sensors 202 and 208. The sensors 202 and 208 are electrically coupled to a printed circuit board (PCB) 104 in the autonomous cooling module 210 via electrical connections 207, e.g., wires. Operation is described further herein. The temperature sensors 202 and 208 sense the temperature of the hair-cutting module 211 and transmit data indicative of the temperature sensed to the PCB 204.

Note that in one embodiment, the hair-cutting module 211 may comprise a fan (not shown). This fan may be coupled to the rotor of the motor 215. The fan can be activated based upon temperature readings from the sensors 202 and 208.

The autonomous cooling module 210 comprises a fan 203. The fan 203 is activated and driven by a motor 216. When the fan 203 is active is has a cooling effect on the internal components of the hair-cutting device 100.

Further, the autonomous cooling module 210 comprises the PCB 204. Coupled to the PCB 204 is a temperature sensor 206 and a microcontroller 205. The temperature sensor 206 is configured to sense the temperature of the autonomous cooling module 210.

Note that a switch 217 may be actuated to activate the fan 203. In this regard, a barber may activate the fan 203 via the switch 217 even when the hair-cutting module is not active. This may allow a barber to cool down his hair-cutting device 100 while it is not in use to prepare the hair-cutting device 100 for future use.

In operation, a barber switches on the hair cutting module 211 and the autonomous cooling module 210. The barber begins to cut a client's hair. While the blade assembly 104 is cutting the client's hair, the temperature sensors 202 and 208 are continuously or at a predetermined interval sampling the temperature of the cutting module 211. Data indicative of the temperatures sensed are transmitted to the microcontroller 205 of the PCB 104 of the autonomous cooling module 210. Simultaneously therewith, the temperature sensor 206 is transmitting data indicative of the temperature of the autonomous cooling module 210 to the microcontroller 205.

The microcontroller 205 compares the data received indicative of the temperatures from the sensors 202 and 208 in the cutting module 211 with a threshold temperature. If the data indicative of the temperatures is greater than the threshold temperature, the microcontroller 205 transmits a signal to the motor 216 activating the fan 203. Also, the microcontroller 205 compares the data indicative of the temperature from the sensor 206 with a threshold temperature. If the data indicative of the temperature is greater than a threshold temperature, the microcontroller 205 transmits a signal to the motor 216 activating the fan 203.

While the fan is continuously cooling down the internal components of the hair-cutting device 100, the microcontroller 205 continues to sample the temperatures from the sensors 202, 208, and 204. The microcontroller 205 compares the data indicative of the temperatures sensed to the threshold temperature. If the data indicative of the temperatures sensed is less than the threshold temperature, the microcontroller 205 transmits a signal to the motor 216 to deactivate the fan 203.

Note that in one embodiment, the housing 103 may comprise ventilation slits (not shown). The ventilation slits may be configured in the hair-cutting module 211 or the cooling module 210. The ventilation slits would allow warm/hot air to escape the housing 103 to further keep the temperature of the hair-cutting device low.

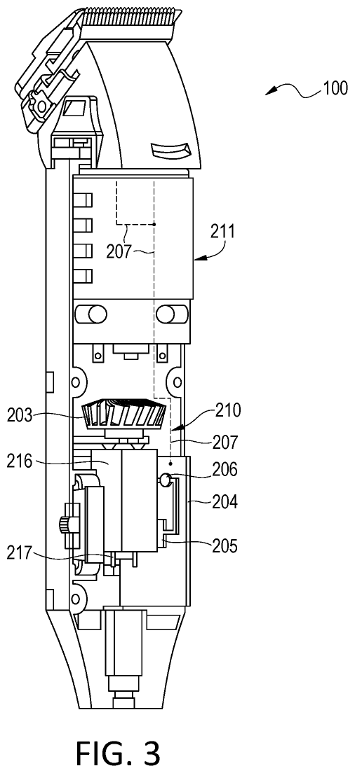

FIG. 3 is a perspective view of the hair-cutting device 100 showing the printed circuit board (PCB) 204, the microcontroller 205 and the temperature sensor 206. The temperature sensor 206 measures the temperature in the autonomous cooling module 210 and transmits data indicative of the temperature sensed to the microcontroller 205.

Further, the sensors 202 and 208 in the cutting module 211 also sense temperature and transmit data indicative of the temperature sensed to the microcontroller 205 on the PCB 204.

Based on the temperatures detected, the microcontroller 205 controls the motor 216 of the fan 203. In this regard, if the temperatures detected are above a threshold, the microcontroller 205 transmits a signal to the motor 216 of the fan 203 activating the fan 203. If the temperatures detected are below the threshold, the microcontroller 205 transmits a signal to the motor 201 of the fan 203 to deactivate the fan 203 if the fan 203 is on.

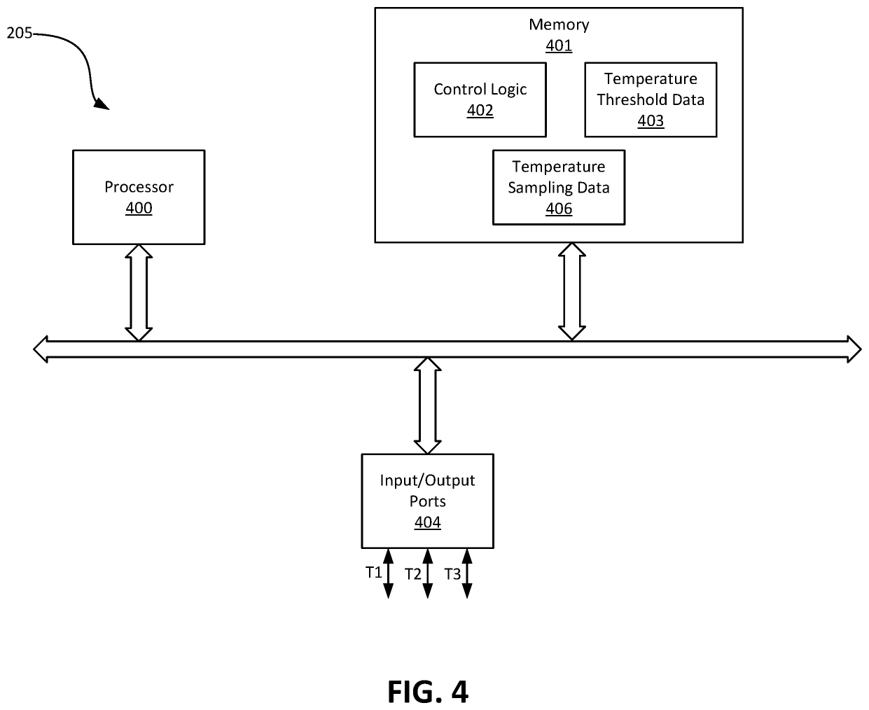

FIG. 4 is a block diagram of an exemplary microcontroller 205 in accordance with an embodiment of the present disclosure. The microcontroller 205 comprises a processor 400, input/output ports 404, and memory 401. Each of these components communicates over local interface 405, which can include one or more buses.

The microcontroller 205 further comprises control logic 402. Control logic 402 can be software, hardware, or a combination thereof. In the exemplary microcontroller 205 shown in FIG. 4, control logic 402 is shown as software stored in memory 401. Memory 401 may be of any type of memory known in the art, including, but not limited to random access memory (RAM), read-only memory (ROM), flash memory, and the like.

When stored in memory 401, control logic 402 can be stored and transported on any computer-readable medium for use by or in connection with an instruction execution system, apparatus, or device, such as a computer-based system, processor-containing system, or other system that can fetch the instructions from the instruction execution system, apparatus, or device and execute the instructions.

In the context of the present disclosure, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium

The microcontroller 205 further comprises temperature threshold data 403 and temperature sampling data 406. The threshold data 403 contains data indicative of temperatures at or above which the cooling module 210 (FIG. 2) activates to cool the hair-cutting device 100. Further, the temperature sampling data 406 comprises data indicative of the temperatures identified by the data received from the sensors 202 (FIG. 2), 208 (FIG. 2), and 206 (FIG. 2).

Processor 400 may be a digital processor or other type of circuitry configured to run the control logic 402 by processing and executing the instructions of the control logic 402. By way of example, the processor 400 may be an 8-bit or a 16-bit processor.

The input/output ports 404 are configured for receiving and transmitting data via lines T1, T2, and T3. In this regard, the sensors 202, 208, and 204 transfer data indicative of temperature samples, and this data is received via the lines T1, T2, and T3 by the input/output ports 404. The control logic 402 stores the data indicative of the temperatures as temperature sampling data 406.

In operation, the hair-cutting device 100 is switched on via switch 212. Once activated, a barber begins cutting a client's hair with the blade 104. During operation of the hair-cutting module 211, the temperature sensors 202 and 208 continuously or periodically sample the temperature of the hair-cutting module 211. Data indicative of the sampled temperatures is transmitted to the microcontroller 205 (FIG. 2) via the electrical lines 207. Notably, the temperatures sensor 206 also continuously or periodically samples the temperature of the cooling module 210. Data indicative of the sampled temperature is transmitted to the microcontroller 205.

Upon receipt of data indicative of the temperatures, the control logic 402 stores the received data as temperature sampling data 406. Further, the control logic 402 compares the data indicative of the temperatures received to the temperature threshold data 403.

If during operation the comparison indicates that the internal components are at a temperature above the temperature threshold data 403, the control logic activates the motor 216, which activates the fan 203. The fan 203 rotates and circulates air throughout the housing 103.

While the fan 203 is rotating, the microcontroller 205 continues to receive data from sensors 202, 208, and 206 indicative of the temperature of the cutting module 211 and the cooling module 210. Further, the microcontroller 205 continues to compare the data indicative of the temperatures received to the temperature threshold data 403.

If the comparison indicates that the temperature in the housing 103 is below the temperature threshold data 403, the microcontroller 205 deactivates the motor 216, which deactivates the fan 203. The microcontroller 205 continues to make comparisons of the data indicative of the temperatures received, and the microcontroller 205 activates and deactivates the motor 216 and the fan 203 accordingly to keep the temperature within the housing 103 at an acceptable level, i.e., a level at which the blades do not overheat or the cutting module does not overheat.

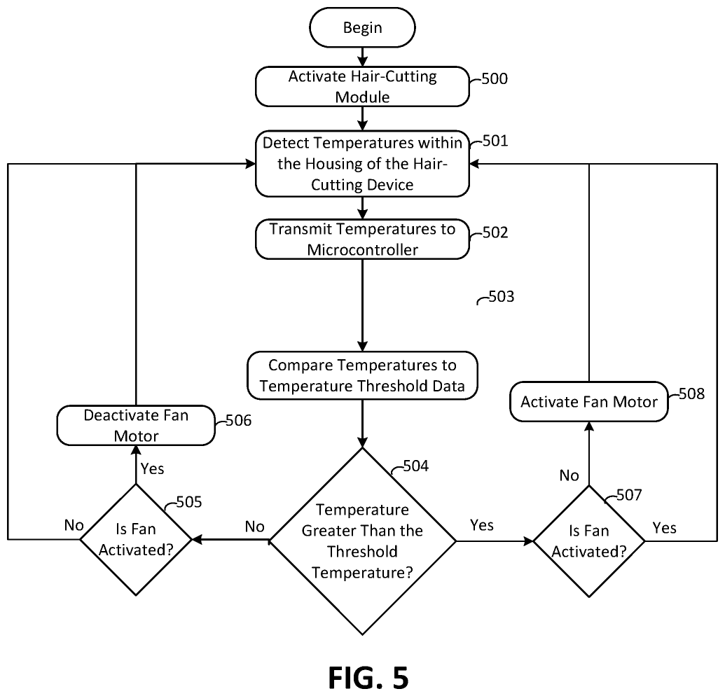

FIG. 5 is a flowchart depicting exemplary functionality of the hair-cutting device 100. In this regard, a barber activates the hair-cutting module 211 (FIG. 2) in step 500. The hair-cutting module 211 may be activated by a switch 212 (FIG. 2). The switch 212 may be on the outer surface of the housing 103 (FIG. 1).

Once the hair-cutting module 211 is activated, the hair-cutting device 100 detects temperatures within the housing 103 of the hair-cutting device in step 501. As described hereinabove, sensors 202 (FIG. 2) and 208 (FIG. 2) detect temperatures of the hair-cutting module 211. The sensor 206 detect the temperature of the cooling module 210 (FIG. 2).

In step 502, the sensors 202, 208, and 206 transmit data indicative of the temperatures detected to the microcontroller 205 (FIG. 5). Note that the sensors 202 and 208 detect temperatures in the cutting module 211, while the sensor 206 detects the temperature in the cooling module 210.

Upon receipt of the data indicative of the temperatures, the microcontroller 205 compares the data indicative of the temperatures received to the temperature threshold data 403 (FIG. 4) in step 503. If the temperature is greater than the threshold temperature in step 504, the microcontroller 205 determines whether the fan 203 (FIG. 2) is already activated.

If the fan 203 is not activated in step 507, the microcontroller 205 activates the motor 216 (FIG. 2), which activates the fan 203 (FIG. 2). If the fan is already activated in step 507, the process starts again at step 501.

If the temperature is not greater than the threshold temperature in step 504, the microcontroller 205 determines whether the fan 203 is already activated. If the fan 203 is activated in step 505, the microcontroller 205 deactivates the motor 216, which deactivates the fan 203 in step 506. The process begins again at step 501.

What I claim is:

1. A modular electric hair cutting device, comprising:
a housing;
a hair-cutting module contained in a first end of the housing, the hair-cutting module comprising blades and configured for cutting hair, the hair-cutting module comprising at least one sensor coupled and configured for detecting a temperature of the hair-cutting module;
a cooling module contained in a second end of the housing, the cooling module comprising a fan and configured to cool the internal components of the housing; and
a processor configured for receiving data indicative of a temperature from the at least one sensor contained in the hair-cutting module and comparing the temperature to a threshold temperature, the processor further configured to activate a first fan if the temperature is greater than the threshold temperature.

2. The modular electric hair-cutting device of claim 1, wherein the hair-cutting module further comprises a second sensor for detecting temperature of the hair-cutting module.

3. The modular electric hair-cutting device of claim 2, wherein the processor is further configured to receive data indicative of a temperature from the second sensor.

4. The modular electric hair-cutting device of claim 3, wherein the processor is further configured to compare the data indicative of the temperature from the second sensor to the temperature threshold data.

5. The modular electric hair-cutting device of claim 4, wherein the processor is further configured to activate the fan if the temperature is greater than the threshold value.

6. The modular electric hair-cutting device of claim 1, wherein the processor is configured to determine if the first fan is active.

7. The modular electric hair-cutting device of claim 6, wherein the processor is further configured to deactivate the first fan if the temperature is less than the temperature threshold data and the first fan is activated.

8. The modular electric hair-cutting device of claim 1, wherein a cutting head of the hair-cutting module is removable.

9. The modular electric hair-cutting device of claim 8, wherein the cutting head is configured to be replaced by a clipper head.

10. The modular electric hair-cutting device of claim 8, wherein the cutting head is configured to be replaced by a trimmer head.

11. The modular electric hair-cutting device of claim 8, wherein the cutting head is configured to be replaced by a shaver head.

12. The modular electric hair-cutting device of claim 1, wherein the hair-cutting module comprises a first motor for driving the blades in the hair-cutting module.

13. The modular electric hair-cutting device of claim 12, wherein the cooling module comprises a second motor for driving a fan that cools the components in the housing when activated.

14. The modular electric hair-cutting device of claim 1, wherein the cooling module comprises a switch that when actuated activates the fan.

15. The modular electric hair-cutting device of claim 14, wherein the fan is configured to be activated even if the hair-cutting module is not operating.

16. The modular electric hair-cutting device of claim 1, wherein the hair-cutting module comprises a second fan.

17. The modular electric hair-cutting device of claim 16, wherein the second fan is activated based upon the temperature detected by the at least one sensor.

18. The modular electric hair-cutting device of claim 1, wherein an outer surface of the housing comprises contoured areas for easy grasping.

19. The modular electric hair-cutting device of claim 1, wherein an outer surface of the housing comprises ventilation slits to allow warm or hot air to escape an inside of the housing.

20. The modular electric hair-cutting device of claim 19, wherein the ventilation slits are on the first end of the housing.

21. The modular electric hair-cutting device of claim 19, wherein the ventilation slits are on the second end of the housing.

22. A modular electric hair-cutting method, comprising:
activating a hair-cutting module of a hair-cutting device;
detecting temperatures via sensors within a housing of the hair-cutting device;
transmitting data indicative of the temperatures detected to a microcontroller;
comparing, by the microcontroller, the detected temperatures to temperature threshold data;
if the temperature is greater than the temperature threshold data and a fan is not activated, activating the fan; and
if the temperature is not greater than the temperature threshold data and the fan is activated, deactivating the fan.
